(19) United States
(12) Patent Application Publication
(10) Pub. No.: US 2006/0136755 A1
(43) Pub. Date: Jun. 22, 2006

(54) System, apparatus, and method to enable and disable a mode of operation of a stacked circuit arrangement on an independent circuit basis using register bits and a single shared mode control line

(76) Inventors: Shekoufeh Qawami, El Dorado Hills, CA (US); Mark Leinwander, Folsom, CA (US); Chaitanya S. Rajguru, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/015,392

(22) Filed: Dec. 16, 2004

(51) Int. Cl. G06F 1/26

(52) U.S. Cl. 713/300

(57) ABSTRACT

System, apparatus, and method to enable and disable a mode of operation of a stacked circuit arrangement on an independent circuit basis using register bits and a single shared mode control line.

### BACKGROUND

The mobile/handheld electronic device market is growing at a rapid pace. Mobile and handheld applications, including digital cameras (e.g., still and motion picture), cellular phones, and personal digital assistants (PDA), among others, share common characteristics such as small size and battery operation. The mobile/handheld application functions are getting stronger to support multimedia service, for example, and thus require increased power consumption. The average size of the mobile/handheld devices, however, is getting smaller and smaller. Thus, these applications require more power without increasing the battery size. In an attempt to minimize power consumption while maintaining or reducing the battery size, certain mobile/handheld devices include components that may be placed in and out of a Deep Power Down (DPD) to minimize overall power consumption. These components may be stacked in a single package or may form a portion of a chipset comprising multiple single or stacked components, for example. Individual control of the DPD mode for a large number of components, however, increases the number of signal routings and pins that a package or chipset must support. In turn, this may require an increase in overall size of the component, package, and/or chipset.

### BRIEF DESCRIPTION OF THE DRAWINGS

FIG. 1 illustrates a block diagram of a system 100.

FIG. 2 illustrates a block diagram of a module 200.

FIG. 3 illustrates a cross sectional view of an integrated circuit array package 300.

FIG. 4 illustrates a block diagram of an integrated circuit array package 400.

FIG. 5 illustrates a timing diagram 500.

FIG. 6 illustrates a block diagram of a programming logic 600.

### DETAILED DESCRIPTION

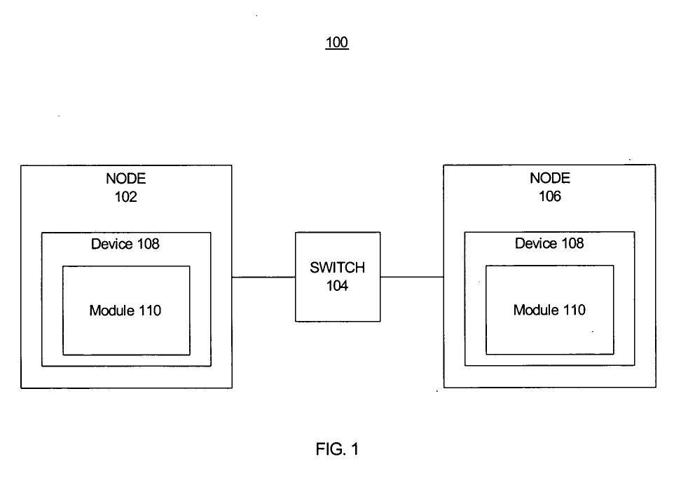

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, digital cameras (e.g., still and motion picture), telephone, cellular telephone, PDA, router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

Nodes 102, 106 of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

Nodes 102, 106 of system 100 may communicate media and control information in accordance with one or more protocols. A protocol may comprise a set of predefined rules or instructions to control how nodes 102, 106 communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth.

System 100 may be implemented as a wired system, a wireless system, or a combination of both. Although system 100 may be illustrated in the context of a wireless system, it may be appreciated that the principles and techniques discussed herein also may be implemented in a wired system as well. The embodiments are not limited in this context.

When implemented as a wired system, system 100 may include one or more nodes 102, 106 arranged to communicate information over one or more wired communications media. Examples of communications media may include metal leads, printed circuit boards (PCB), backplanes, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes 102, 106 using a desired set of communications protocols, services or operating procedures. The I/O adapters also may include the appropriate physical connectors to connect the I/O adapters with a corresponding communications media. Examples of an I/O adapter may include a network interface, a network interface card (NIC), disc controller, video controller, audio controller, and so forth. The embodiments are not limited in this context.

When implemented as a wireless system, system 100 may include one or more wireless nodes 102, 106 arranged to communicate information over one or more types of wireless communication media. An example of a wireless communication media may include portions of a wireless spectrum, such as the radio-frequency (RF) spectrum. Wireless nodes 102, 106 may include components and interfaces suitable for communicating information signals over the designated RF spectrum. Wireless nodes 102, 106 also may include additional components and interfaces such as one or more antennas, wireless RF transceivers, amplifiers, filters, control logic, and so forth. The antenna may comprise, for example, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

Embodiments of system 100 and accompanying devices may include, for example, Code Division Multiple Access (CDMA), Global System for Mobile Communications (GSM), North American Digital Cellular (NADC), Time Division Multiple Access (TDMA), Extended-TDMA (E-TDMA), third generation (3G) systems like Wide-band CDMA (WCDMA), CDMA-2000, and so forth.

Wireless nodes 102, 106 may comprise a switch such as a WAP, a mobile switching center (MSC), a wireless base station or Node B, a radio network controller (RNC), and so forth. A mobile switching center may comprise, for example, a telephone switch, similar to a central office switch that bridges a mobile wireless telephone network with another telephone network such as the public switched telephone network (PSTN). A wireless base station may provide: air interface transmission; reception, modulation; demodulation, CDMA physical channel coding, micro diversity, error handing, and closed loop power control, for example. Other examples may comprise a base transceiver station (BTS) to act as transmit and receive link for a mobile communication system to communicate with a mobile phone, for example. A base transceiver station connects to a base station controller (BSC) over a T1/E1 line. A base station controller works with one or more BTSs to act as a link between wireless devices such as cellular phones and the wireline telephone network. Wireless nodes 102, 106 also may comprise, for example, an RNC to provide wireless data services to act as a link between wireless devices such as an internet-enabled mobile phones and the Internet, for example.

Wireless nodes 102, 106 also may comprise wireless devices or apparatuses such as electronic devices, handheld electronic devices, battery operated electronic devices, portable electronic devices, wireless devices including transceivers, transmitters, and receivers of a radio system. A wireless device may comprise a mobile or cellular phone, a computer equipped with a wireless access card or modem, a handheld client device such as a wireless PDA, an integrated cellular telephone/PDA. A radio system intended to be included within the scope of the embodiments include, by way of example only, cellular radiotelephone communication systems, satellite communication systems, two-way radio communication systems, one-way pagers, two-way pagers, personal communication systems (PCS), PDA systems, and the like.

Nodes 102, 106 may communicate information to each other in the form of packets, for example. A packet in this context may refer to a set of information of a limited length, with the length typically represented in terms of bits or bytes. An example of a packet length might be 64 bytes. For example, node 102 may break a set of media information into a series of packets. Each packet may contain a portion of the media information plus some control information. The control information may assist various intermediate nodes, between nodes 102, 106, for example, to route each packet to its intended destination, such as node 106. The destination node 106 may receive the entire set of packets and use them to reproduce the media information communicated from node 102. Although FIG. 1 is shown with a limited number of nodes arranged in a certain topology, it may be appreciated that system 100 may include more or less nodes arranged in a variety of topologies as desired for a given implementation. The embodiments are not limited in this context.

In one embodiment, system 100 may comprise switch 104, which may comprise for example, a switch, router, and the like, (collectively referred to herein as “switch 104”) to provide a communication bridge between nodes 102 and 106. Switch 104 also may operate in accordance with one or more media access control protocols, such as from the IEEE 802.3 series of Ethernet protocols, among others. For example, switch 104 may be a high bandwidth switch, such as a Fast Ethernet switch operating at 100 megabits per second (Mbps), a Gigabit Ethernet switch operating at 1000 Mbps, and so forth. The embodiments are not limited in this context.

In one embodiment, switch 104 may comprise an interface between a base station system and a switching subsystem of a mobile phone network such as, for example, an MSC, BSC, RNC, BTS, Node B, or the like. In this context, switch 104 may comprise control and switching elements for a cellular system, housed by a Mobile Telephone Switching Office (MTSO), for example, acting as a “middleman” between cell sites and the PSTN, processing traffic back and forth, to control calls to and from other telephone and data systems. Also, switch 104 may play a role in subscriber roaming by providing all the necessary functionality involved in registering, authenticating, location updating, and call routing for a roaming subscriber, for example.

Switch 104 may switch packets between the various nodes of the system 100. For example, switch 104 may switch packets from a source node 102 to a destination node 106. Each packet may include a source address and destination address. The switch 104 may receive the packet, retrieve the destination address, and send the packet to an intermediate node or destination node based on the destination address. System 100 may operate to transfer information between node 102 and node 106 via switch 104. Switch 104 may comprise one or more processors to communicate information (e.g., packets) between the switch 104 and any of one of the nodes 102, 106, for example.

Referring again to FIG. 1, in one embodiment, system 100 may comprise nodes 102 and 106, which may comprise device 108. In one embodiment, device 108 may further comprise module 110, for example. In one embodiment, module 110 may comprise a circuit, an integrated circuit, an integrated circuit array, a chipset comprising an integrated circuit or an integrated circuit array, a logic circuit, a memory, an element of an integrated circuit array or a chipset, a stacked integrated circuit array. In one embodiment, a chipset may comprise multiple single or stacked integrated circuits or a combination of both. In one embodiment, module 110 may comprise a stacked flash memory array for wireless cell phones and handheld devices. Embodiments of device 108 and module 110 are described below.

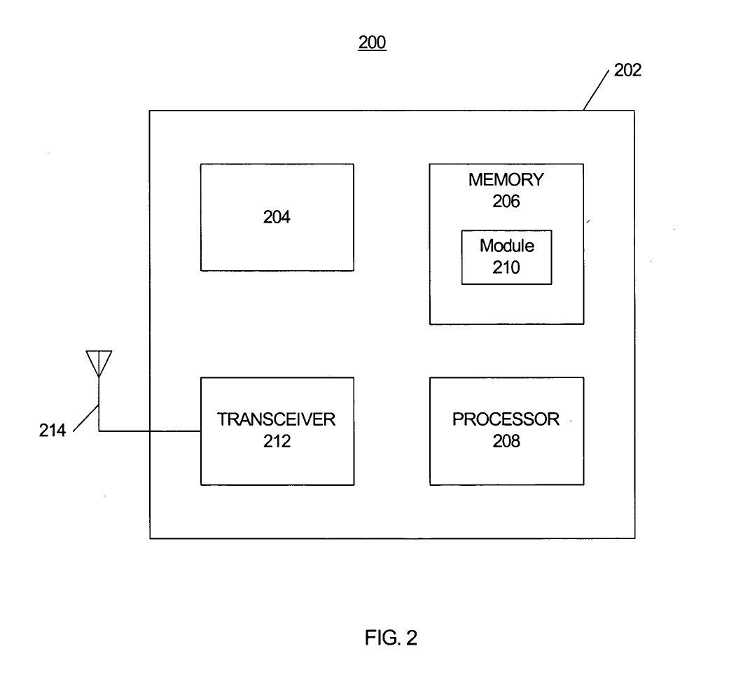

FIG. 2 illustrates a block diagram of a module 200. Some elements of module 200 may be implemented using, for example, one or more circuits, components, registers, processors, software subroutines, or any combination thereof. Although FIG. 2 shows a limited number of elements, it may be appreciated that more or less elements may be used in module 200 as desired for a given implementation. The embodiments, however, are not limited in this context. In one embodiment, module 200 may represent device 108 of nodes 102, 106 as described with reference to FIG. 1. As shown in FIG. 2, module 200 may comprise multiple elements, such as in one embodiment, computing system 202, for example. In one embodiment, module 200 may comprise a handheld device as well as devices suitable for implementation of networking, automotive, set-top box, tele/data communications, and measurement equipment applications. In one embodiment, a handheld device may comprise, for example, a portable device, a wireless device, a wireless communication device, a mobile communication device (e.g., cellular telephone), a two-way radio communication system, a pager (e.g., a one-way pager, a two-way pager), a PCS device, a portable computer, a PDA, an MP3 device, a multimedia device, a GPS unit, a portable electronic game, a laptop computer, a digital still or motion picture camera, a DVD device, a DVD picture book, and an iPod device, among others, for example. Further, in one embodiment, for example, the multiple elements may comprise one or more wireless nodes, which may comprise wireless devices developed in accordance with the Personal Internet Client Architecture (PCA) by Intel® Corporation, for example. Although it should be understood that the embodiments or the examples are not limited in this context.

Computing system 202 also may comprise a display 204 to provide information to a user, a memory 206, and a processor 208 that may comprise one or more integrated circuits, although the scope of the embodiments is not limited in this context. In on embodiment, processor 208 may comprise a controller to control the operation of memory 206 and/or module 210, for example. Memory 206 may represent module 110 of nodes 102, 106 as described with reference to FIG. 1. Processor 208 may comprise, for example, a microprocessor, a digital signal processor, a microcontroller, or the like. Processor 208 may be used to execute instructions to provide information or communications to a user. Instructions to be executed by processor 208 may be stored in memory 206, although the scope of the embodiments is not limited in this context.

Memory 206 may comprise any machine-readable media. Some examples of machine-readable media include, but are not necessarily limited to, read-only memory (ROM), random-access memory (RAM), dynamic RAM (DRAM), double-data-rate DRAM (DDRAM), synchronous RAM (SRAM) or DRAM (SDRAM), programmable ROM, erasable programmable ROM, electronically erasable programmable ROM, flash memory, a polymer memory such as ferroelectric polymer memory, an ovonic memory, magnetic or optical cards, or any other type of media suitable for storing electronic instructions.

Further, in one embodiment, memory 206 also may comprise a stacked integrated circuit array. In one embodiment, memory 206 may comprise a chipset comprising multiple single or stacked integrated circuit arrays or a combination of both. In one embodiment, memory 206 may comprise a stacked memory array 210 or a chipset comprising multiple single or stacked memory arrays. One example of a stacked memory array may be the L18/L30 Stacked Chip Scale Packaging (Stacked-CSP) product portfolio by Intel®. In one embodiment, stacked memory array 210 may provide wireless users with a memory package that uses less physical space by combining high-density Intel StrataFlash® Memory with flexible RAM options, for example. Other examples of the memory 206 include XIP code flash (Sibley) and data flash on P805 also by Intel®.

Computing system 202 also may comprise a transceiver 212 and an antenna 214 to provide wireless communication with other devices. Although the scope of the embodiments is not limited in this context, transceiver 212 may permit computing system 202 to communicate using one of the communication standards listed above. Alternatively, computing system 202 may include hardware to permit it to communicate with or as part of a wireless local area network (WLAN).

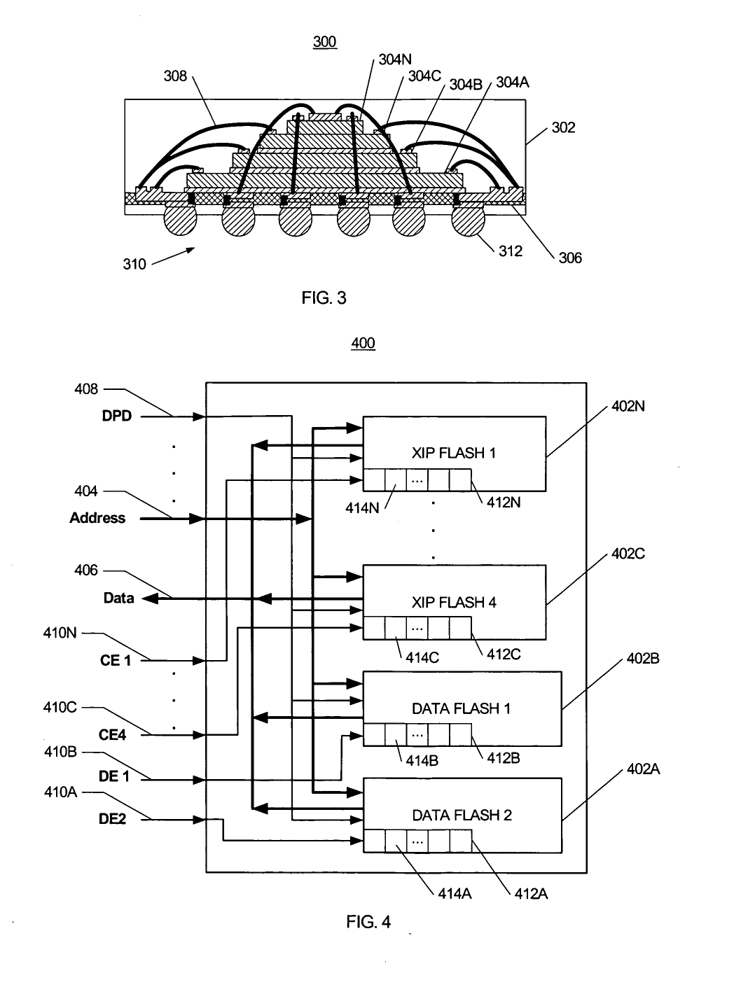

FIG. 3 illustrates a sectional view of one embodiment of a stacked integrated circuit array 300. Stacked integrated circuit array 300 may comprise an encapsulation package 302 to house a plurality of stacked integrated circuit devices 304A, B, C, N, where N may represent the maximum number of devices that may be supported in a single package 302 based on present or future technology. Stacked integrated circuit array 300 may further comprise a substrate 306 and a plurality of wire bonds 308 to interconnect devices 304A, B, C, N with substrate 306, for example. Substrate 308 is connected or coupled to a plurality of pins 310 illustrated herein as bumps 312 to communicate electrical impulses to and from devices 304A, B, C, N, for example, although embodiments are not limited in this context.

Stacked integrated circuit devices 304A, B, C, N may comprise a Silicon die, for example, and in one embodiment, devices 304A, B, C, N may represent individual memory devices. The memory devices may be stacked flash memories, for example. Stacked flash memory arrangements are particularly useful in today's cellular and PDA market where flash memory is used in stacked packages with other flash memory or memory components to provide increased memory density where physical space is at a premium. In one embodiment, the flash memory stack may include up to six or more devices, although embodiments are not limited in this context. Also, some applications may require a chipset system design where multiple stacked integrated circuit arrays 300 may be used. Designs comprising multiple stacked integrated circuit arrays 300, however, may require additional pins 310, which may take up valuable physical space. In such designs, therefore, it may be beneficial to share one or more pins within a particular stacked integrated circuit array 300 or share pins between multiple stacked integrated circuit arrays 300 in a chipset to limit the number of signal routings and pins that a package or chipset must support.

FIG. 4 illustrates a block diagram of one embodiment of a stacked integrated circuit array package 400 comprising a plurality of stacked integrated circuit devices 402A, B, C, N, where N may represent devices 304A, B, C, N the maximum number of devices that may be supported in a single package 400 based on present or future technology. In one embodiment, devices 402A, B, C, N may represent devices 304A, B, C, N as described with reference to FIG. 3, for example. Devices 402A, B, C, N may have a variety of operational modes; some of which may be used to reduce the amount of power consumed by computing system 202 shown in FIG. 2. For example, although the scope of the embodiments are not limited in this context, devices 402A, B, C, N may have an active mode during which it consumes power and an inactive operational mode during which it does not consume power or in which power consumption is minimized. Although the scope of the embodiments is not limited in this context, in one particular embodiment, the active mode may represent a condition during which computing system 202 in FIG. 2 may be in use by a user whereas the inactive mode may occur if the user turns the computing system 202 off or places it in a stand-by, low power mode. When in the low power operational mode, computing system 202 may halt or slow down the execution of instructions in an attempt to reduce its power consumption. A controller may be used to place devices 402A, B, C, N in and out of active modes by changing the state on DPD signal 408 to reduce leakage current associated with devices 402A, B, C, N. Placing devices 402A, B, C, N in and out of active modes may be referred to herein as placing devices 402A, B, C, N in and out of DPD mode, for example.

Devices 402A, B, C, N may comprise registers 412A, B, C, N, respectively. Integrated circuit array package 400 also may comprise a common address line 404 and a common data line 406 connected or coupled to each of devices 402A, B, C, N. In one embodiment, address line 404 and data line 406 may comprise one or more physical lines to carry one or more signals, for example. Package 400 also may comprise a common DPD signal 408 connected to each of the stacked devices 402A, B, C, N, for example. Common DPD signal 408 may be connected to two or more of the devices 402A, B, C, N, for example. In one embodiment, devices 402A, B, C, N may comprise stacked data flash memories, XIP code flash memories or a combination thereof. Common DPD signal 408 may be used in flash memories and in battery operated applications, for example, to reduce the leakage current associated with flash memories and its effect on the battery stand by time. DPD signal 408 may be used to shut off all internal circuits of devices 402A, B, C, N and ignore all input lines except for DPD signal 408 to maximize the power saving during DPD mode.

Although the scope of the embodiments is not limited in this context, stacked integrated circuit array package 400 also may comprise one or more chip enable lines 410A, B, C, N to receive an enable control signal to control or indicate when devices 402A, B, C, N are in a drowsy, stand-by, sleep, low power DPD mode, and the like. In one embodiment, enable lines 410A, B, C, N may be connected or coupled to registers 412A, B, C, N, respectively, for example, to individually select any one of devices 402A, B, C, N and place them in DPD mode individually. Although devices 402A, B, C, N may be placed in DPD mode individually, the multiple devices 402A, B, C, N that are in DPD mode will come out of DPD mode at the same time. Although the scope of the embodiments are not limited in this context, the enable control signal on enable lines 410A, B, C, N may be an active high signal or, in other embodiments, an active low signal. The state of the enable control signal also may be monitored to determine when devices 402A, B, C, N are placed in the DPD operational mode.

Stacked integrated circuit devices 402A, B, C, N (e.g., stacked flash memories) may be placed in and out of DPD mode in several ways. In one embodiment devices 402A, B, C, N may enter and exit DPD mode by way of a command from a memory controller, for example. In this embodiment, however, once devices 402A, B, C, N are in DPD mode some input pins and some internal circuits may have to remain active in order to exit DPD mode. In one embodiment, an enable control signal (e.g., DPD signal 408) may be asserted to enter DPD mode whereas a command may be used to deactivate or disable DPD mode, for example. In another embodiment, an enable control signal (e.g., DPD signal 408) may be asserted/de-asserted to enter/exit DPD mode, for example. Once DPD mode is asserted, all internal circuits of devices 402A, B, C, N may be shut-off and all other inputs except for the DPD input may be ignored to maximize power saving. To add pins or inputs for every device 402A, B, C, N in stacked package 400 or in a chipset comprising multiple stacked packages may require some additional signal routings and pins, for example.

In one embodiment, a single shared DPD signal 408 may be used to receive an enable or disable control signal to place stacked integrated circuit devices 402A, B, C, N in or out of DPD mode. In one embodiment all stacked integrated circuit devices 402A, B, C, N may share DPD signal 408, for example. In one embodiment, stacked package 400 or chipset comprising multiple devices 402A, B, C, N (e.g., flash memory devices) may include registers 412A, B, C, N, respectively, to individually control devices 402A, B, C, N. Each register 412A, B, C, N may comprise a register bit 414A, B, C, N, respectively, to enable/disable DPD mode for a specific device 402A, B, C, N. Thus a memory controller may individually set/reset register bit 414A, B, C, N in conjunction with asserting/de-asserting common DPD signal 408 to enable/disable DPD mode in individual devices 402A, B, C, N. In one embodiment, when register bit 414A, B, C, N is reset, corresponding devices 402A, B, C, N will ignore the enable control signal (e.g., DPD signal 408). For example, where package 400 comprises a stack of multiple flash memory devices, or a chipset comprising multiple flash memory devices, a memory controller may enable DPD mode in some of flash memory devices 402A, B, C, N while disabling DPD mode in the remaining flash memory devices 402A, B, C, N to maintain them active. In one embodiment, once common DPD signal 408 is used, only devices 402A, B, C, N with a set register bit 414A, B, C, N respond to an enable control signal, such as common DPD signal 408. Thus, register bits 414A, B, C, N used in conjunction with common DPD signal 408 provides individual control of DPD mode for each device 402A, B, C, N.

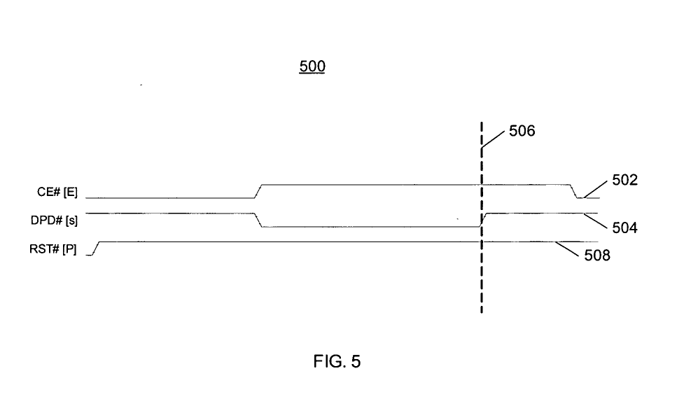

FIG. 5 illustrates a timing diagram 500 for placing a device 402A, B, C, N in DPD mode. In this illustration, a device 402A, B, C, N will be placed in DPD mode when a register bit 414A, B, C, N has been set by appropriately sequencing the enable control signal 502 and other relevant signals in a corresponding register 412A, B, C, N and a DPD signal 504 is asserted on at rising edge 506. Those skilled in the art will appreciate, however, that the DPD signal 504 polarity may be programmed either way to place device 402A, B, C, N in DPD mode. In one embodiment, register bit 414A, B, C, N may be set or enabled by appropriately sequencing the enable control signal 502 and other relevant signals on enable control line 410A, B, C, N. When a register bit 414A, B, C, N is reset or disabled, by appropriately asserting reset signal 508, the corresponding device 402A, B, C, N does not respond to the common DPD signals 504.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

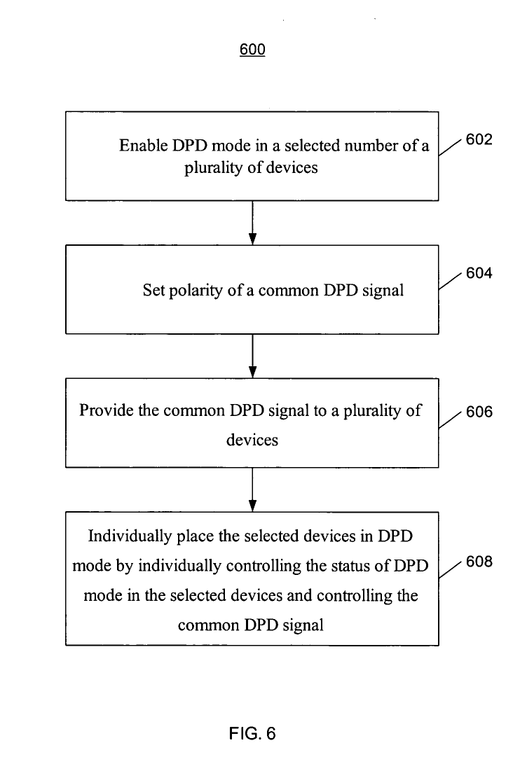

FIG. 6 illustrates a programming logic 600. Programming logic 600 may be representative of the operations executed by one or more systems described herein, such as system 100 and/or module 200. As shown in programming logic 600, at block 602 the system enables a mode in a selected number of a plurality of devices. In one embodiment, enabling a mode comprises enabling a deep power down mode of the selected devices. The devices may include, for example, memories. At block 604, the system set a polarity of a common mode signal, and at block 606, the system provides the common mode signal to a plurality of devices. Setting a polarity of a common mode signal comprises setting a polarity of a common deep power down mode signal. At block 608, the system individually places the selected devices in the mode (e.g., deep power down mode). In one embodiment, individually placing the selected devices in the mode comprises individually controlling the status of deep power mode in the selected number of devices and controlling the common mode signal.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be understood that embodiments may be used in a variety of applications. Although the embodiments are not limited in this context, the circuits disclosed herein may be used in many apparatuses such as in electronic devices, battery operated electronic devices, portable electronic devices, wireless devices including transceivers, transmitters, and receivers of a radio system. Radio systems intended to be included within the scope of the embodiments include, by way of example only, cellular radiotelephone communication systems, satellite communication systems, two-way radio communication systems, one-way pagers, two-way pagers, personal communication systems (PCS), personal digital assistants (PDA's) and the like. Electronic devices include cellular telephones, PDA's, Moving Pictures Expert Group (MPEG) layer III (MP3) devices, multimedia devices, global positioning system (GPS) navigation devices, portable games, digital video disk (DVD) devices, DVD video picture books, and iPod, for example.

While certain features of the embodiments have been illustrated as described herein, many modifications, substitutions, changes and equivalents will now occur to those skilled in the art. It is therefore to be understood that the appended claims are intended to cover all such modifications and changes as fall within the true scope of the embodiments.

1. An apparatus, comprising:
a first circuit, wherein said first circuit comprises:
a first register;
a first input to receive a first control signal to control a polarity of a status bit of said first register; and
a second input to receive a second control signal;
wherein a mode of operation of said first circuit is enabled by controlling said polarity of said status bit of said first circuit and a polarity of said second control signal.

2. The apparatus of claim 1, further comprising:
a second circuit, wherein said second circuit comprises:
a first register;
a first input to receive a first control signal to control a polarity of a status bit of said first register; and
a second input to receive said second control signal;
wherein a mode of operation of said second circuit is enabled by controlling said polarity of said status bit of said second circuit and a polarity of said second control signal.

3. The apparatus of claim 2, wherein said second input of said first circuit is commonly connected to said second input of said second circuit.

4. The apparatus of claim 3, wherein said mode of operation of said first circuit is controlled independently of said mode of operation of said second circuit.

5. The apparatus of claim 2, wherein said first and second circuits comprises memories.

6. The apparatus of claim 5, wherein said memories comprises flash memories.

7. The apparatus of claim 6, wherein said mode of operation comprises a deep power down mode.

8. The apparatus of claim 1, further comprising:
a plurality of circuits, wherein each of said plurality of circuits comprises:
a first register;
a first input to receive a first control signal to control a polarity of a status bit of said first register; and
a second input to receive said second control signal;
wherein a mode of operation of each of said plurality of circuits is enabled by controlling said polarity of said status bit in each of said plurality of circuits and a polarity of said second control signal.

9. The apparatus of claim 8, wherein said second input of said first circuit is commonly connected to each of said second inputs of said plurality of circuits.

10. The apparatus of claim 9, wherein said mode of operation of said first circuit is controlled independently of said mode of operation of each of said plurality of circuits.

11. The apparatus of claim 8, wherein said first circuit and each of said plurality of circuits comprises memories.

12. The apparatus of claim 11, wherein said memories comprises flash memories.

13. The apparatus of claim 12, wherein said mode of operation comprises a deep power down mode.

14. The apparatus of claim 1, wherein said first circuit comprises a second register and wherein said second register comprises a status bit to determine a polarity of operation of said second control signal.

15. The apparatus of claim 14, wherein said mode of operation of said first circuit is enabled by controlling said polarity of said status bit of said second register and wherein said polarity of said second control signal transitions from a low logic state to a high logic state.

16. The apparatus of claim 14, wherein said mode of operation of said first circuit is enabled by controlling said polarity of said status bit of said second register and wherein said polarity of said second control signal transitions from a high logic state to a low logic state.

17. A system, comprising:
an antenna;
a network interface connected to said antenna; and
a device connected to said interface, said device to include:
a first register;
a first input to receive a first control signal to control a polarity of a status bit of said first register;
a second input to receive a second control signal; and
wherein a mode of operation of said first circuit is enabled by controlling said polarity of said status bit of said first circuit and a polarity of said second control signal.

18. The system of 17, further comprising:
a second circuit, wherein said second circuit comprises:
a first register;
a first input to receive a first control signal to control a polarity of a status bit of said first register; and
a second input to receive said second control signal;
wherein a mode of operation of said second circuit is enabled by controlling said polarity of said status bit of said second circuit and a polarity of said second control signal.

19. The system of claim 18, wherein said second input of said first circuit is commonly connected to said second input of said second circuit.

20. The system of claim 19, wherein said mode of operation of said first circuit is controlled independently of said mode of operation of said second circuit.

21. The system of claim 18, wherein said first and second circuits comprises memories.

22. The system of claim 21, wherein said memories comprises flash memories.

23. The system of claim 22, wherein said mode of operation comprises a deep power down mode.

24. The system of claim 17, further comprising:
a plurality of circuits, wherein each of said plurality of circuits comprises:
a first register;
a first input to receive a first control signal to control a polarity of a status bit of said first register; and
a second input to receive said second control signal;
wherein a mode of operation of each of said plurality of circuits is enabled by controlling said polarity of said status bit in each of said plurality of circuits and a polarity of said second control signal.

25. The system of claim 24, wherein said second input of said first circuit is commonly connected to each of said second inputs of said plurality of circuits.

26. The system of claim 25, wherein said mode of operation of said first circuit is controlled independently of said mode of operation of each of said plurality of circuits.

27. The system of claim 24, wherein said first circuit and each of said plurality of circuits comprises memories.

28. The system of claim 27, wherein said memories comprises flash memories.

29. The system of claim 28, wherein said mode of operation comprises a deep power down mode.

30. A system, comprising:
a processor;
a memory connected to said processor, said memory to include:
a first register;
a first input to receive a first control signal to control a polarity of a status bit of said first register; and
a second input to receive a second control signal;
wherein a mode of operation of said first circuit is enabled by controlling said polarity of said status bit of said first circuit and a polarity of said second control signal.

31. The system of 30, further comprising:
a second circuit, wherein said second circuit comprises:
a first register;
a first input to receive a first control signal to control a polarity of a status bit of said first register; and
a second input to receive said second control signal;
wherein a mode of operation of said second circuit is enabled by controlling said polarity of said status bit of said second circuit and a polarity of said second control signal.

32. The system of claim 31, wherein said second input of said first circuit is commonly connected to said second input of said second circuit.

33. The system of claim 31, wherein said mode of operation of said first circuit is controlled independently of said mode of operation of said second circuit.

34. The system of claim 31, wherein said first and second circuits comprises memories.

35. The system of claim 34, wherein said memories comprises flash memories.

36. The system of claim 31, wherein said mode of operation comprises a deep power down mode.

37. The system of claim 30, further comprising:
a plurality of circuits, wherein each of said plurality of circuits comprises:
a first register;
a first input to receive a first control signal to control a polarity of a status bit of said first register; and
a second input to receive said second control signal;
wherein a mode of operation of each of said plurality of circuits is enabled by controlling said polarity of said status bit in each of said plurality of circuits and a polarity of said second control signal.

38. The system of claim 37, wherein said second input of said first circuit is commonly connected to each of said second inputs of said plurality of circuits.

39. The system of claim 38, wherein said mode of operation of said first circuit is controlled independently of said mode of operation of each of said plurality of circuits.

40. The system of claim 37, wherein said first circuit and each of said plurality of circuits comprises memories.

41. The system of claim 40, wherein said memories comprises flash memories.

42. The system of claim 37, wherein said mode of operation comprises a deep power down mode.

43. A method, comprising:
enabling a mode in a selected number of a plurality of devices;
setting a polarity of a common mode signal;
providing said common mode signal to a plurality of devices; and
individually placing said selected devices in said mode.

44. The method of claim 43, wherein enabling a mode comprises enabling a deep power down mode.

45. The method of claim 43, wherein setting a polarity of a common mode signal comprises setting a polarity of a common deep power down mode signal.

46. The method of claim 43, wherein individually placing said selected devices in said mode comprises individually controlling the status of deep power mode in said selected number of devices and controlling said common mode signal.
